(19) United States
(12) Patent Application Publication
(10) Pub. No.: US 2026/0235889 A1
(43) Pub. Date: Aug. 13, 2026

(54) SPORTS SUNGLASSES

(71) Applicant: Chongqing Roupai Optical Technology Co., Ltd., Chongqing (CN)

(72) Inventors: Qiang Chen, Yongcheng (CN); Linfa Jin, Linhai (CN); Tianbao Zheng, Xianfeng (CN)

(21) Appl. No.: 19/637,434

(22) Filed: Apr. 2, 2026

(30) Foreign Application Priority Data
Feb. 6, 2026 (CN) 202610173099.8

(51) Int. Cl. G02C 3/00; G02C 7/10

(52) U.S. Cl. CPC G02C 3/00; G02C 7/10; G02C 2200/08

(57) ABSTRACT

Sports sunglasses are provided, including a frame, temples and a nose support, the temples being hinged to both end parts of the frame, and two sunglass lenses being installed on the frame. The sports sunglasses further include two lens rims, an optical lens being installed inside each lens rim. At least one first engaging slot is formed on an inner side of the frame above the sunglass lens, and a first engaging head mated with the first engaging slot is provided on an outer side of the lens rim, the two lens rims being engaged into the corresponding first engaging slots through respective first engaging heads thereof. When the first engaging heads are engaged into the corresponding first engaging slots, the first engaging heads can slide certain distance toward the end parts of the frame from a middle part thereof, forming an accommodation groove between the two lens rims.

### TECHNICAL FIELD

The present disclosure relates to the technical field of glasses, more particularly to sports sunglasses.

### BACKGROUND

Sports sunglasses refer to safety protective glasses worn during sports and generally have functions of safety, protection, comfort and aesthetics. However, most existing sports sunglasses mainly focus on sports performance while neglecting whether the installed lenses can meet the special needs of myopic individuals or not, therefore they often fail to meet the requirements of standard optical parameters and cannot satisfy both sports use and professional optical needs of myopic prescriptions, leaving myopic individuals unable to fully enjoy their sports activities.

In view of the above, sports goggles are designed out and disclosed in the patent with application number CN201720612053.8. The sports goggles comprise a frame 1, temples 2, sunglass lenses 3 and myopic lenses 4. The sunglass lenses 3 are installed inside the frame 1. Cross sections of the sunglass lenses 3 are curved, and the sunglass lenses 3 can cover the front end of the eyes. A nose support 9 is installed on an inner side of a middle part of the frame 1, and a round hole 16 is formed in a middle part of the nose support 9. The nose support 9 is made of an engineering plastic. The round hole 16 enables a ventilation and heat dissipation effect. The nose support 9 is fixed on the frame 1 by means of a screw 10, and the screw 10 passes through the nose support 9 to be installed in a corresponding screw hole formed on the frame 1. The myopic lenses 4 are arranged on the nose support 9, and magnet sheets are embedded in the myopic lenses 4, enabling the myopic lenses 4 to be attached to the inner side of the frame 1. Although the above solution can address the issue of myopic individuals wearing glasses during sports, the method of attaching the myopic lenses to the inner side of the frame 1 via magnetic sheets presents stability problems, and the myopic lenses are still prone to falling off during intense exercise.

### SUMMARY

The present disclosure aims to address the drawbacks of the existing technology and provide sports sunglasses stable in structure and convenient to assemble and disassemble.

To achieve the above aim, the present disclosure provides sports sunglasses, including a frame, temples and a nose support, the temples being hinged to both end parts of the frame, and two sunglass lenses being installed on the frame, wherein the sports sunglasses further include two lens rims, an optical lens being installed inside each lens rim. At least one first engaging slot is formed on an inner side of the frame above the sunglass lens, and a first engaging head mated with the first engaging slot is provided on an outer side of the lens rim, the two lens rims being engaged into the corresponding first engaging slots through respective first engaging heads thereof. When the first engaging heads are engaged into the corresponding first engaging slots, the first engaging heads can slide certain distance toward the end parts of the frame from a middle part thereof, forming an accommodation groove between the two lens rims. A second engaging slot is formed at a bottom of a bridge of the frame, and a second engaging head is provided on the nose support. While the nose support is engaged into the second engaging slot through the second engaging head, the nose support is embedded into the accommodation groove to press and fix the two lens rims.

Preferably, the first engaging head is of an L shaped structure, including a first arm and a second arm, one end of the first arm being connected to the outer side of the lens rim while the other end thereof being perpendicularly connected to one end of the second arm. The first engaging slot includes an insertion slot part and a sliding slot part, the insertion slot part being communicated with the sliding slot part, the insertion slot part having a greater width than that of the first arm, and the sliding slot part being dimensionally matched with the second arm. When the first engaging head is inserted into the first engaging slot from the insertion slot part, the second arm can slide along the sliding slot part.

Preferably, the nose support includes a bracket part, a connection arm and a pad part, the second engaging head being arranged on an outer side of the bracket part, and the pad part being fixed on an inner side of the bracket part through the connection arm.

Preferably, the connection arm is in a π-shaped structure, an upper end of the π-shaped structure being a fixing tab; an installation slot is formed on the inner side of the bracket part; and a screw hole is formed at a bottom end of the bracket part, a screw being threaded into the screw hole, and the screw extending through the installation slot to secure the fixing tab into the installation slot.

Preferably, two first engaging slots are formed on the inner side of the frame above each sunglass lens; and two first engaging heads are provided on the outer side of the lens rim correspondingly.

Preferably, the pad part is of an elastic material, one side of the pad part facing a nasal bridge being provided with a plurality of anti-slip ribs.

Preferably, the temples are formed with lightening holes.

Preferably, the temples are formed with lightening grooves.

Compared to the existing technology, the present disclosure has the following beneficial effects. By means of the embedded engagement manner, combined with the nose support for pressing and fixation, the lens rims can be effectively fixed on the frame, avoiding the optical lens shaking and falling off, thereby enhancing the user experience for myopic individuals. The assembly process is simple, typically requiring only an embedded sliding action, after which the nose support can achieve press-fit fixation. This enables fast and convenient assembly, facilitates the replacement of optical lenses with different diopters, thus can meet the personalized requirements of various users.

### BRIEF DESCRIPTION OF THE DRAWINGS

FIG. 1 is an overall structural view of the sports sunglasses of the present disclosure.

FIG. 2 is an exploded structural view of the sports sunglasses of the present disclosure.

FIG. 3 is a structural view, from inside, of the sports sunglasses of the present disclosure.

FIG. 4 is a sectional view of FIG. 3 taken along line A-A.

FIG. 5 is a sectional view of FIG. 3 taken along line B-B.

FIG. 6 is an exploded structural view of a nose support of the present disclosure.

In the drawings: 1, frame; 1a, first engaging slot; 1a1, insertion slot part; 1a2, sliding slot part; 1b, second engaging slot; 2, temple; 2a, lightening hole; 2b, lightening groove; 3, nose support; 3a, bracket part; 3a1, second engaging head; 3a11, engaging block; 3a12, guide curved surface; 3a2, installation slot; 3a3, screw hole; 3b, connection arm; 3b1, fixing tab; 3c, pad part; 3c1, anti-slip rib; 4, sunglass lens; 5, lens rim; 5a, first engaging head; 5a1, first arm; 5a2, second arm; 6, optical lens; 7, accommodation groove.

### DETAILED DESCRIPTION OF THE EMBODIMENTS

The technical solution of the present disclosure is described below in further detail in conjunction with the accompanying drawings and through specific embodiments.

Herein, the accompanying drawings are only for illustrative purposes, representing merely schematic diagrams rather than physical drawings, which shall not be construed as limiting the present disclosure. For better illustrating the embodiments of the present disclosure, some components in the accompanying drawings might be omitted, enlarged or reduced, which do not represent the dimensions of the actual product. It will be understood by those skilled in the art that some well-known structures and their descriptions might be omitted from the accompanying drawings.

In the accompanying drawings of the embodiments of the present disclosure, the same or similar designators are used for representing the same or similar elements. In the description of the present disclosure, it is to be understood that the orientation or position relations indicated by such terms as “upper”, “lower”, “left”, “right”, “inner”, “outer”, etc. are based on the orientation or position relations shown in the drawings, and are merely for conveniently describing the present disclosure and simplifying the description, rather than indicating or implying that the device or element must have the specific orientation and be constructed and operated according to the specific orientation. Therefore, those terms describing positional relationships in the accompanying drawings are for illustrative purposes only and shall not be construed as limiting the present patent. For the ordinary skill in the art, the specific meanings of the above terms can be understood depending on actual situations.

It is to be noted that in this paper relational terms such as “first”, “second”, etc. are merely used to distinguish one entity or operation from another, and do not necessarily require or imply any such actual relationship or order between these entities or operations. In addition, terms “comprising”, “including” or any other variation thereof are intended to refer to a non-exclusive inclusion, such that a process, method, article, or apparatus that comprises a list of elements does not include only those elements but may include other elements not expressly listed or inherent to such process, method, article, or apparatus. Without further limitations, an element defined by the phrase “comprising a/an...” does not exclude the presence of additional identical elements in a process, method, article, or apparatus that includes the stated elements.

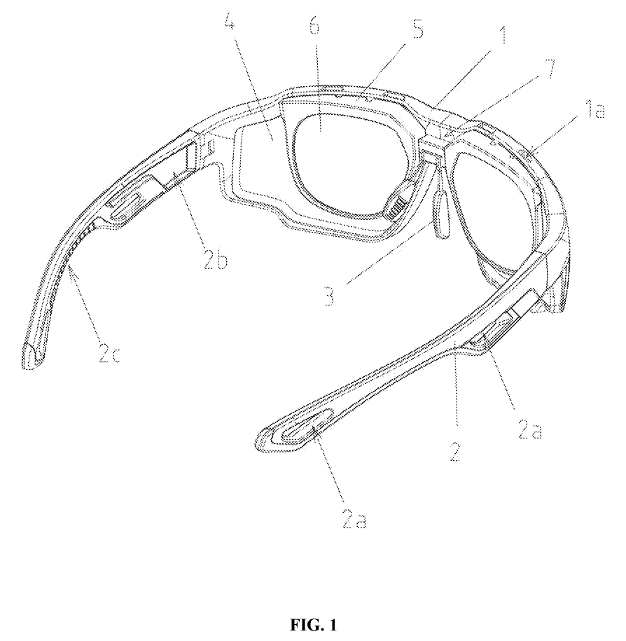

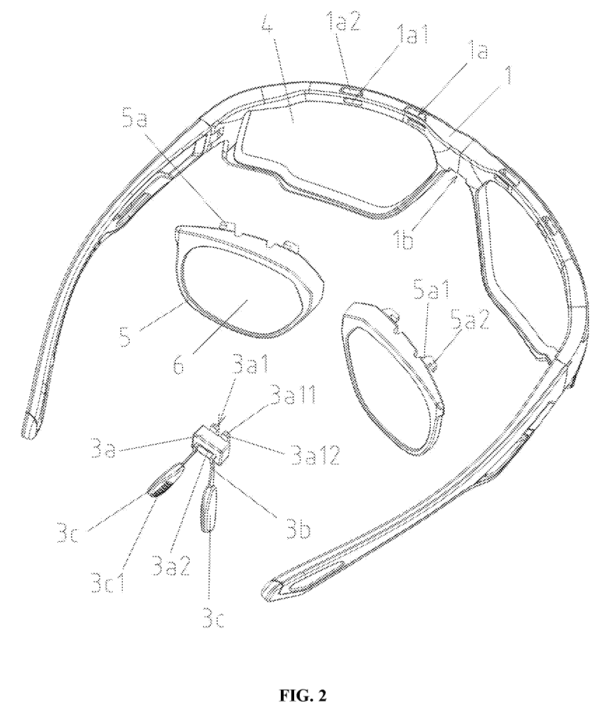

As shown in FIG. 1 and FIG. 2, the sports sunglasses according to the present disclosure include a frame 1, temples 2 and a nose support 3, the temples 2 being hinged to both end parts of the frame 1, and two sunglass lenses 4 being installed on the frame 1. Two lens rims 5 are provided on an inner side of the frame 1, and an optical lens 6 is installed inside each lens rim 5. Two first engaging slots 1a are formed on the inner side of the frame 1 above each sunglass lens 4, and first engaging heads 5a mated with the first engaging slots 1a are provided on outer sides of the lens rims 5. The lens rims 5 are engaged into the corresponding first engaging slots 1a through respective first engaging heads 5a thereof, and when the first engaging heads 5a are engaged into the corresponding first engaging slots 1a, the first engaging heads 5a can slide certain distance toward the end parts of the frame 1 from a middle part thereof, forming an accommodation groove 7 between the two lens rims 5. A second engaging slot 1b is formed at a bottom of a bridge of the frame 1, and a second engaging head 3a1 is provided on the nose support 3; and while the nose support 3 is engaged into the second engaging slot 1b through the second engaging head 3a1, the nose support 3 is embedded into the accommodation groove 7 to press and fix the two lens rims 5. The temples 2 are formed with lightening holes 2a and lightening grooves 2b.

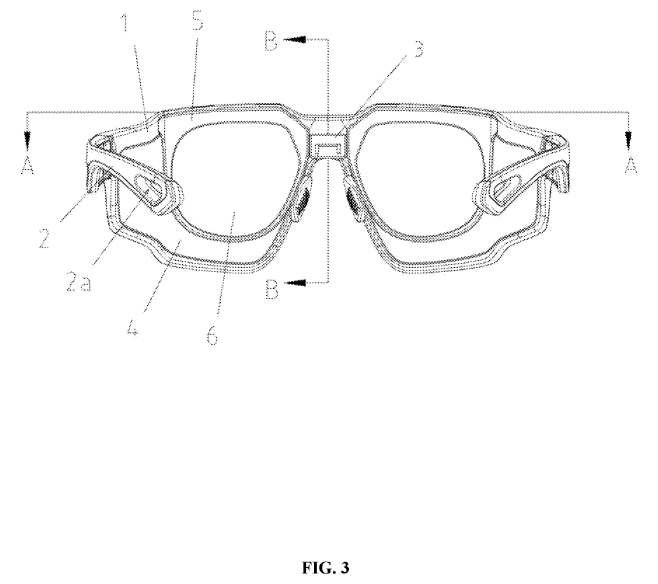

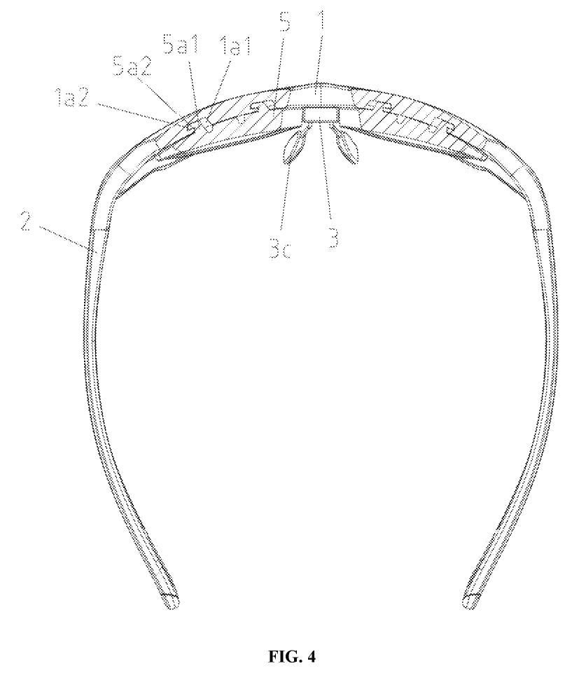

With reference to FIG. 3 and FIG. 4, specifically, the first engaging head 5a is of an L shaped structure, including a first arm 5a1 and a second arm 5a2, one end of the first arm 5a1 being connected to the outer side of the lens rim 5 while the other end thereof being perpendicularly connected to one end of the second arm 5a2. The first engaging slot 1a includes an insertion slot part 1a1 and a sliding slot part 1a2; the insertion slot part 1a1 is communicated with the sliding slot part 1a2; the insertion slot part 1a1 has a greater width than that of the first arm 5a1; and the sliding slot part 1a2 is dimensionally matched with the second arm 5a2. When the first engaging head 5a is inserted into the first engaging slot 1a from the insertion slot part 1a1, the second arm 5a2 can slide along the sliding slot part 1a2.

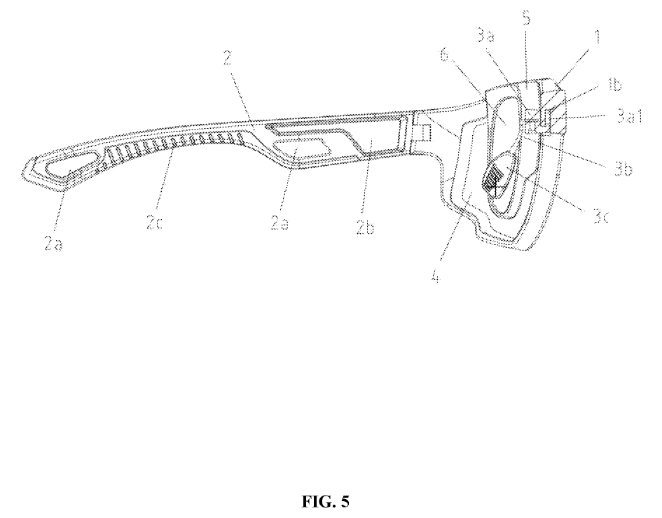

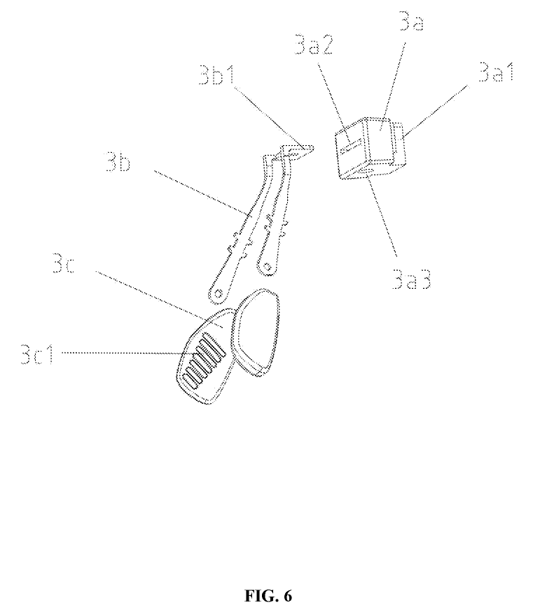

With reference to FIG. 5 and FIG. 6, the nose support 3 includes a bracket part 3a, a connection arm 3b and a pad part 3c; the second engaging head 3a1 is arranged on an outer side of the bracket part 3a; and the pad part 3c is fixed on an inner side of the bracket part 3a through the connection arm 3b. The second engaging head 3a1 includes two engaging blocks 3a11 arranged in parallel; and end parts of the engaging blocks 3a11 are provided with guide curved surfaces 3a12. A gap is reserved between the two engaging blocks 3a11, and the entire width of the second engaging head 3a1 is slightly greater than that of the second engaging slot 1b. When the second engaging head 3a1 is inserted into the second engaging slot 1b, the two engaging blocks 3a11 are slightly deformed to move toward each other under a squeezing force. In this way, after the second engaging head 3a1 is inserted into the second engaging slot 1b, the second engaging head 3a1 is tightly clamped into the second engaging slot 1b by means of the deformation force of the engaging blocks 3a11 to form a tight fit. The connection arm 3b is in a π-shaped structure, and an upper end of the π-shaped structure is a fixing tab 3b1; an installation slot 3a2 is formed on the inner side of the bracket part 3a; a screw hole 3a3 is formed at a bottom end of the bracket part 3a; and a screw is threaded into the screw hole 3a3, and the screw extends through the installation slot 3a2 to secure the fixing tab 3b1 into the installation slot 3a2. The pad part 3c is of an elastic material, and one side of the pad part 3c facing a nasal bridge is provided with a plurality of anti-slip ribs 3c1.

The operation principle of the present disclosure is as follows: during installation, two lens rims 5 equipped with optical lenses 6 are inserted into the insertion slot parts 1a1 of the corresponding first engaging slots 1a through respective first engaging heads 5a thereon, and then they are pushed toward two end parts of the frame 1, enabling the first engaging heads 5a to slide toward the two end parts of the frame 1 along the sliding slot parts 1a2 of the first engaging slots 1a, forming an accommodation groove 7 between the two lens rims 5. The accommodation groove 7 is located on an inner side of the bridge of the frame 1. Then, the second engaging head 3a1 of the nose support 3 is inserted upward into the second engaging slot 1b, meanwhile the bracket part 3a of the nose support 3 is embedded into the accommodation groove 7, pressing against the ends of the two lens rims 5 close to the middle part, thereby fixing the two lens rims 5.

The above are merely preferred specific embodiments of the present disclosure, and the protection scope of the present disclosure is not limited thereto. Any equivalent substitutions or changes made within the technical scope of the present disclosure by those skills familiar with the technical field according to the technical solution of the present disclosure and the inventive conception are all intended to be included in the scope of protection of the disclosure.

What is claimed is:

1. Sports sunglasses, comprising a frame (1), temples (2) and a nose support (3), the temples (2) being hinged to both end parts of the frame (1), and two sunglass lenses (4) being installed on the frame (1), wherein the sports sunglasses further comprise two lens rims (5) corresponding to the sunglass lenses (4) in position, an optical lens (6) being installed inside each lens rim (5); wherein at least one first engaging slot (1a) is formed on an inner side of the frame (1) above the sunglass lens (4), and a first engaging head (5a) mated with the first engaging slot (1a) is provided on an outer side of the lens rim (5), the two lens rims (5) being engaged into the corresponding first engaging slots (1a) through respective first engaging heads (5a) thereof, and wherein when the first engaging heads (5a) are engaged into the corresponding first engaging slots (1a), the first engaging heads (5a) can slide certain distance toward the end parts of the frame (1) from a middle part thereof, forming an accommodation groove (7) between the two lens rims (5); wherein a second engaging slot (1b) is formed at a bottom of a bridge of the frame (1), and a second engaging head (3a1) is provided on the nose support (3), and wherein while the nose support (3) is engaged into the second engaging slot (1b) through the second engaging head (3a1), the nose support (3) is embedded into the accommodation groove (7) to press and fix the two lens rims (5).

2. The sports sunglasses according to claim 1, wherein the first engaging head (5a) is of an L shaped structure, comprising a first arm (5a1) and a second arm (5a2), one end of the first arm (5a1) being connected to the outer side of the lens rim (5) while the other end thereof being perpendicularly connected to one end of the second arm (5a2); wherein the first engaging slot (1a) comprises an insertion slot part (1a1) and a sliding slot part (1a2), the insertion slot part (1a1) being communicated with the sliding slot part (1a2), the insertion slot part (1a1) having a greater width than that of the first arm (5a1), and the sliding slot part (1a2) being dimensionally matched with the second arm (5a2); and wherein when the first engaging head (5a) is inserted into the first engaging slot (1a) from the insertion slot part (1a1), the second arm (5a2) can slide along the sliding slot part (1a2).

3. The sports sunglasses according to claim 1, wherein the nose support (3) comprises a bracket part (3a), a connection arm (3b) and a pad part (3c), the second engaging head (3a1) being arranged on an outer side of the bracket part (3a), and the pad part (3c) being fixed on an inner side of the bracket part (3a) through the connection arm (3b).

4. The sports sunglasses according to claim 3, wherein the connection arm (3b) is in a π-shaped structure, an upper end of the π-shaped structure being a fixing tab (3b1); wherein an installation slot (3a2) is formed on the inner side of the bracket part (3a); and wherein a screw hole (3a3) is formed at a bottom end of the bracket part (3a), a screw being threaded into the screw hole (3a3), and the screw extending through the installation slot (3a2) to secure the fixing tab (3b1) into the installation slot (3a2).

5. The sports sunglasses according to claim 1, wherein two first engaging slots (1a) are formed on the inner side of the frame (1) above each sunglass lens (4), and wherein two first engaging heads (5a) are provided on the outer side of the lens rim (5) correspondingly.

6. The sports sunglasses according to claim 3, wherein the pad part (3c) is of an elastic material, one side of the pad part (3c) facing a nasal bridge being provided with a plurality of anti-slip ribs (3c1).

7. The sports sunglasses according to claim 1, wherein the temples (2) are formed with lightening holes (2a).

8. The sports sunglasses according to claim 7, wherein the temples (2) are formed with lightening grooves (2b).
